(19) United States
(12) Patent Application Publication
(10) Pub. No.: US 2010/0255904 A1
(43) Pub. Date: Oct. 7, 2010

(54) Method for making photo-sticker via game console

(76) Inventors: Chira Kidakarn, Lawndale, CA (US); Michael Kidakarn, Lawndale, CA (US)

Correspondence Address: DAVID AND RAYMOND PATENT FIRM, 108 N. YNEZ AVE., SUITE 128, MONTEREY PARK, CA, 91754, US

(21) Appl. No.: 12/798,395

(22) Filed: Apr. 1, 2010

Related U.S. Application Data
(60) Provisional application No. 61/211,729, filed on Apr. 1, 2009.

(51) Int. Cl. A63F 13/00; A63F 9/24

(52) U.S. Cl. 463/30; 463/43

(57) ABSTRACT

The present invention provides a method for making photo-sticker via the game consoles, wherein the method includes the steps of (a) providing a game console; (b) installing an editing software to a storage of the game console; (c) inputting an image to the storage for being edited; (d) executing the editing software by a processing system; (e) editing the inputted image to be a photo-sticker via an interface of the editing software; and (f) transmitting the edited image of photo-sticker to a printing device, so as to make the photo-sticker. The editing software installed into the game console as an add-on function allows the user to simply, inexpensively, and portably make the photo-sticker via the enjoyable game console.

### CROSS REFERENCE OF RELATED APPLICATION

This is a non-provisional application of a provisional application, application No. 61/211,729, filed Apr. 1, 2009.

### BACKGROUND OF THE PRESENT INVENTION

1. Field of Invention

The present invention relates to a method for making photo-sticker, and more particularly to a method for making photo-sticker via game consoles, wherein a game consoles allows a user to edit any images as the user's desire to form a photo-sticker.

2. Description of Related Arts

Photo-sticker is extremely popular for printing and/or editing the images captured by a capturing device. There are various kinds of machine for making the photo-sticker. A photo vending machine provided in a photo shop, shopping mall, or other public place is common and usually attracts lots of people for taking a picture through the vending machine.

It allows immediately capturing a pose of an object, such as creatures, and promptly editing the captured images with plenty of special functions or effects to make the photo more interesting. The user can add a background to the captured image, decorative photo rims for enhancing the visual effects, or even printing it out as stickers for sharing with friends or family, or keeping it.

However, those vending machines tend to be expensive. The user has to insert a considerable amount of money just for taking a set of photo-sticker or one picture. It is hard for most of people taking lots of photo-stickers with their friends as many as they want.

There are still a number of other disadvantages in a relation to this kind of vending machine for making photo-stickers or pictures. First, the vending machine is provided for making a photo-sticker or a picture which is limited on making the images captured by this vending machine only. It is hard for the user editing any images they want and inserting an interesting template or features on any images, such as an image from a memory card or camera.

Secondly, the portability of those kinds of vending machines is an issue. It is usually heavy, huge, and hard to be moved. The images can not be taken anywhere, anytime for editing or making the photo-stickers or the likes. An improved method of making the photo-sticker or the picture is strongly desired.

### SUMMARY OF THE PRESENT INVENTION

A main object of the present invention is to provide a method for making a photo-sticker or picture, wherein the method is incorporated with a game console, such that a user is allowed editing and making the photo-sticker or the likes via the game console.

Another object of the present invention is to provide a method for making a photo-sticker or picture, wherein the game console has a storage for storing an editing software executed by a processing system of the game console, so as for the user to edit an image anytime he or she wants.

Another object of the present invention is to provide a method for making a photo-sticker or picture, wherein the game console provided for the method of making the photo-sticker is preferably a portable game console to enhance the portability of making the photo-sticker, so that the user can edit the images anytime anywhere.

Another object of the present invention is to provide a method for making a photo-sticker, wherein the editing software is incorporated with the game console as an add-on feature or program of the game console, so that no complicated manufacturing process is involved, so as to reduce the manufacturing cost.

Another object of the present invention is to provide a method for making a photo-sticker, wherein the edited image via the game console is capable of being outputted to another electronic device for saving purpose or printed out via an external printing device.

Another object of the present invention is to provide a method for making a photo-sticker, wherein the game console can be further incorporating with an external image capturing device or external memory device for receiving the images saved therein, so that the user is able to edit any images by the game console.

Another object of the present invention is to provide a method for making a photo-sticker, wherein the game console comprises a built-in lens for capturing images anywhere anytime.

Another object of the present invention is to provide a method for making a photo-sticker, wherein the method incorporated with the game console provides an inexpensive way for making the photo-sticker anywhere anytime.

Accordingly, in order to accomplish the above objects, the present invention provides a method for making photo-sticker comprising the steps of (a) obtaining an image to store in a storage 20 of the game console; (b) displaying the image on a display 30 of the game console; (c) editing the image via an editor 21 stored in the storage of the game console through a communicating device of the game console; and (d) making the image to form a photo-sticker in the game console.

Accordingly, in order to accomplish the above objects, the present invention also provides a game console device for making photo-sticker comprising a processing system, a storage for storing an editing software, a communicating device for communicating between a user and the game console and editing the inputted image for making the photo-sticker, and at least one connecting slot for being connected to an external device for inputted an image to the storage of the game console for being edited.

Therefore, the game console is capable of editing the inputted image for making the photo-sticker, and transmitting the edited image to a printing device by wire or wirelessly, so as to make the photo-sticker.

These and other objectives, features, and advantages of the present invention will become apparent from the following detailed description, the accompanying drawings, and the appended claims.

### BRIEF DESCRIPTION OF THE DRAWINGS

FIG. 1 is a flow chart of the method of making photo-sticker via a game console according to a preferred embodiment of the present invention.

FIG. 2 is a block diagram of the editor stored in the game console according to the preferred embodiment of the present invention.

FIG. 3 is a block diagram of a game console for making photo-sticker according to the preferred embodiment of the present invention.

FIG. 4 is a perspective view of the game console for making photo-sticker according to the preferred embodiment of the present invention.

### DETAILED DESCRIPTION OF THE PREFERRED EMBODIMENT

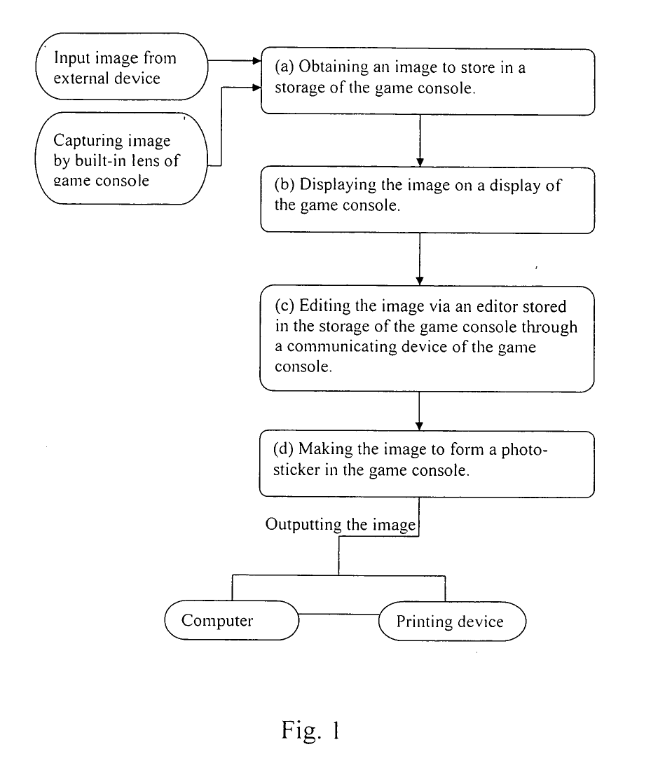

Referring to FIG. 1 of the drawings, a method for making photo-sticker according to a preferred embodiment of the present invention is illustrated, wherein the method of making photo-sticker via a game console which can be home game console or portable game console device for playing video game. Accordingly, the method comprises the following steps.

(a) Provide the game console, wherein the game console includes home game console or portable game console device.

(b) Provide an editor 21 to a storage 20 of the game console, wherein the editing software is digitally installed thereat for electrically connecting to a processing system 10 of the game console. The editor 21 can be an editing software installed into the game console as an add-on function allows the user to simply, inexpensively, and portably make the photo-sticker via the enjoyable game console.

(c) Input an image to the storage 20 for being edited.

(d) Execute the editor 21 by the processing system 10 of the game console.

(e) Edit the inputted image to form a photo-sticker format, wherein the inputted image is able to be temporarily or permanently saved in the storage 20 for being edited. The editor 21 may further has an interface 211 electrically connecting to the processing system 10, in such a manner that the inputted image saved at the storage 20 and electrically connected to the processing system 10 is able to be edited via the interface 211, so as to design and form the photo-sticker.

(f) Transmit the edited image to a printing device for making the photo-sticker of the edited image. A photo sticker print for the printing device may further provided, so that the user is able to simply transmit the edited image to the printing device to be printed out as desired photo-sticker.

The image can be obtained through connecting an external device to the game console, such that the image being saved in the external device is able to be obtained and inputted to the storage 20 of the game console. The external device is capable of saving and/or capturing an image through connecting the external device to the game console, wherein the image is being inputted from the external device through a connecting slot 51 of a transmitting device 50 of the game console, so that through the connecting slot 51, the image is transmitted into the storage 20 of the game console for further editing. In order words, the external device is connected with the game console preferably through a connecting cable or USB connector, wherein the connecting cable is extended from the external device by one end, and being plugged into the connecting slot 51 by the other end, so as to transmitting the image information to the game console. The transmitting device 50 may further comprise a wireless connecter 51, such as Bluetooth or far infrared, for wirelessly transmitting signals between the game console and the external device or the likes.

The external device is a device which is capable of saving, storing, or capturing the image therein, such as a camera or a hard drive. Take the camera as an example, after the camera captured the image of a pose of an object, and saved the image into the memory card of the camera, the image is able to be transmitted to the game console via the connecting slot 51 for editing the image as the photo-sticker.

The image also can be obtained through a built-in lens 60 of the game console, wherein the built-in lens 60 is adapted for capturing the image directly through the built-in lens and inputting to the storage 20 of the game console. The built-in lens 60 is electrically connected to the storage 20 of the game console for later processing. Therefore, in the step (c), the image also can be obtained via the built-in lens 60 through capturing an image by the built-in lens of the game console itself, and directly inputting the image information to the storage 20 of the game console, so as to portably capture and edit the image into the photo-sticker whenever and wherever the user is hoping to make the photo-sticker.

It is worth mentioning that the built-in lens 60 of the game console enhances the portability of capturing the image, convenience of obtaining the image, and the portability of editing the image anywhere and anytime. The user can bring the portable game console with the built-in lens, capturing the image whenever and wherever the user wants, and editing the image immediately.

Accordingly, in the step (d), after the editor 21 is being activated, the inputted image is able to be posted or displayed on the display 30 of a communicating device of the game console, so as for being edited via the editing software21.

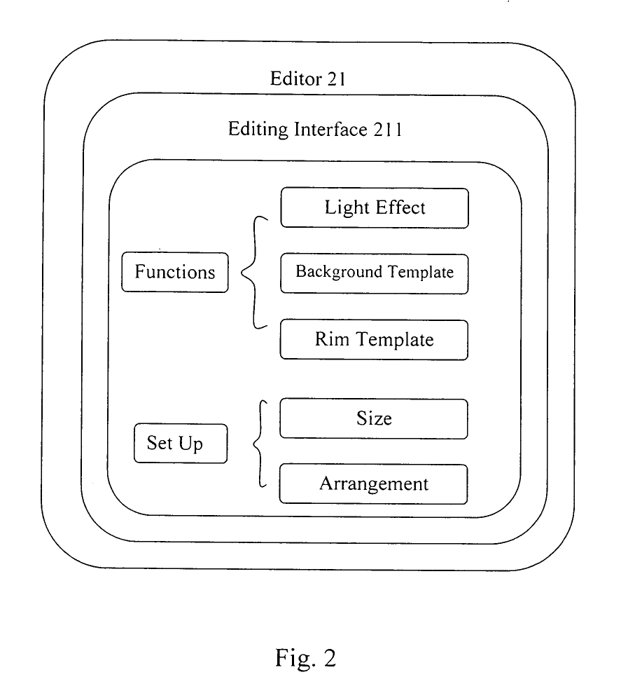

As shown in FIG. 2, the editor 21 of the game console comprises an interface 211 including a plurality of functions, set up, etc., wherein the functions have a plurality of templates for selectively adding a background, rim, or the likes to the image obtained by the game console. The functions of the editor 21 also have a plurality of effects, such as a light effect for making the image darker, brighter, old fashion style, and shiny, a twist effect for making the image twisted in an artist purpose, and the likes. The editor 21 further has a decoration function, wherein the decoration function allows the user to add a plurality of saved-into-storage images on the obtained image from the external device or the built-in lens 60, such as an apple, a cloud, a flower, a dog, or a car etc.

The editor 21 also includes a plurality of setting functions, wherein the setting function is provided for selectively set up a size and/or the arrangement of the photo-sticker. For example, the setting function allows the user to select the way to make the photo-sticker two in a row. Through the functions of the editor 21 for the user selectively editing the image, the user can enjoy editing the image to be the photo-sticker simply via the game console.

The editor 21 is adapted to incorporate with the game console; preferably a portable game console for enhancing the portability of the method for making photo- sticker, wherein the editor 21 is installed into the game console as an add-on feature of the game console, so that a user can enjoy playing with the game console and editing the images into an interesting photo-sticker at the same time.

In order to efficiently and conveniently edit the image via the game console, the communicating device of the game console is provided for communicating between the user and the game console, so that the user is able to edit or select the function of the game console. The communicating device further comprises a controller 40 for inputting and editing the image, and the display 30 for displaying the image from the game console, in such manner that the image is able to be edit through the controller 40 via the interface 211 of the editor 21 of the game console.

The display 30 comprises a touch screen 31, integrally mounted on a top surface of the display 30 and electrically connected to the processing system 10 of the game console, in such manner that the display 30 further provides an input function for communicating with the game console by touching the touch screen 31 of the display 30. In order words, the touch screen 31 of the display 30 and the controller 40 are capable of allowing the user to selectively edit or input commons to the processing system 10 of the game console. The touch screen 31 of the display 30 makes the editing relatively easier and more convenient for the user for editing.

After accomplished editing the image, in the step (f), the edited image is able to be outputted, wherein the edited image is being outputted to a computer or a printing device for making the photo-sticker according to the edited image, size and arrangement that the user set up by the editor 21 of the game console.

The game console further comprises a transmitting device 50 provided for receiving the image to be inputted for editing the image and outputted after the image is being edited to form the photo-sticker, wherein the transmitting device 50 is capable of outputting the edited image wirely or wirelessly. The transmitting device 50 may further computer a connecting slot 51 for a cable or USB connector to plug thereinto for inputting or outputting the image therethrough.

The method of making photo-sticker via the game console effectively enhanced the portability of capturing images and editing the captured images simply via the game console. The user has no need to buy another device for making the photo-sticker. While enjoying the game console for playing the video games installed and saved in the storage 20 of the game console, the user is able to promptly enjoy the editing fun of the add-on function of making photo-sticker at the same time.

It should be noted that the method for making photo stickers via the game consoles may also include those home game consoles. Preferably, the game console is not a communication device such as a mobile phone with game function. In other words, the game console is a video game playing device for play video game only. Since the game console already built-in with display 30, the digital storage 20, and the controller 40, the editor 21 can be simply provided in the game console to add an additional photo-sticker making function by using the existing components of the game console. For examples, the home game console of “Wii”, “Nintendo DS”, “PSP”, “Xbox” or the like, which is able to electrically connect with personal device, such as personal computer for uploading pictures therefrom, so that the method of making photo sticker is able to provide kids to creatively and simply make the photo stickers via any of the game console without intensely or complicatedly learning process. In other words, even the kids are able to give the ordinary photo with decoratively nice touch and design, so as to inspiringly educate the kid while playing the game console. It is appreciated that the image resolution obtained by the game console is relatively low quality, since the photo-sticker is usually smaller then a normal picture. It is unnecessary to have a high quality image for making the photo-sticker.

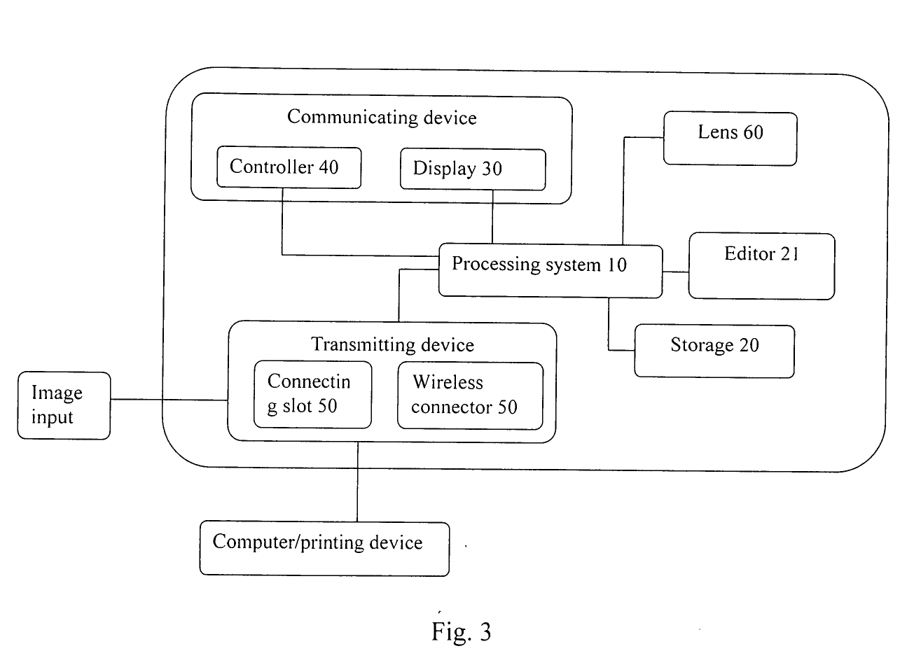

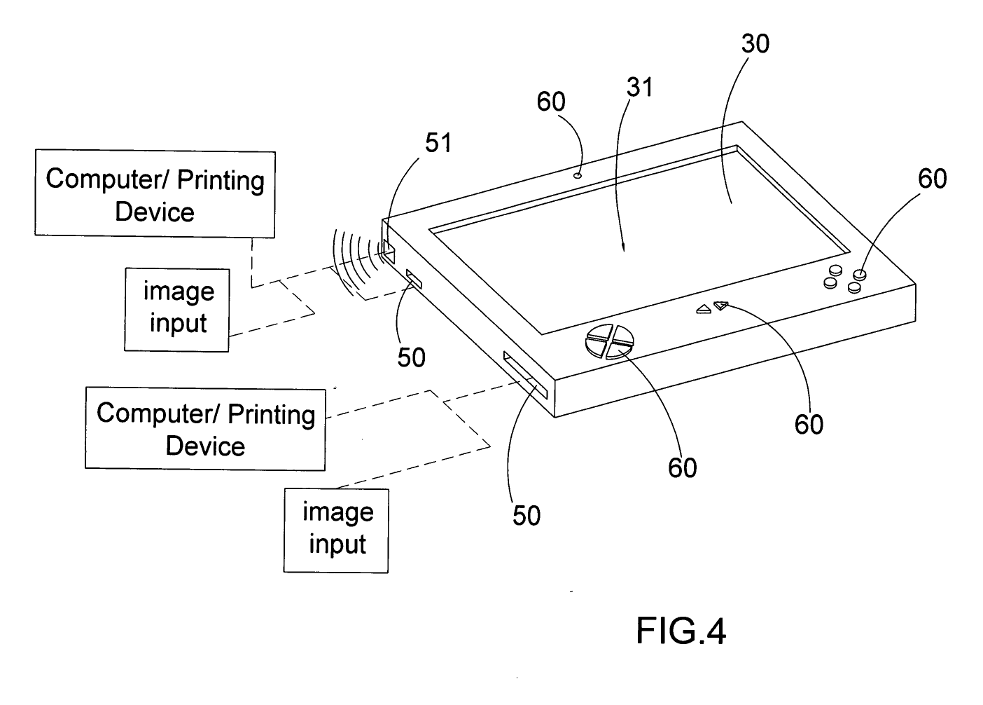

Referring to FIGS. 3 and 4, in order to achieve the goal of the present invention, a game console device is provided for making photo-sticker, wherein the game console comprises a processing system 10, a storage 20 for storing an editor 21, a communicating device for communicating between a user and the game console, and a transmitting device 50 adapted for inputting or outputting information, such as an image of picture, wherein the transmitting device 50 comprises at least one connecting slot 51 for connecting to an external device, wherein the external device is capable of saving, storing, or capturing an image, so as to input the image to the storage 20 of the game console, in such a manner that the image of the external device is able to be sent and stored in the storage 20 and edited by the editor 21 via the processing system 10 executing the editor 21, so as to be edited through the communicating device of the game console.

The connecting slot 51 is adapted for being electrically connected to a connecting cable of the external device for inputting the image from the external device. It is worth mentioning that the external device is a device which is capable of saving, storing, or capturing the image therein, such as a camera or a hard drive. Take the camera as an example, after the camera captured the image of a pose of an object, and saved the image into the memory card of the camera, the image is able to be transmitted to the game console for editing the image as a photo-sticker. It is appreciated that the transmitting device 50 may further comprise the wireless connector 52, such as Bluetooth or far infrared, for wirelessly transmitting the information or signals between the game console, the external device, or the likes.

According to the game console device of the present invention, the communicating device comprises a display 30 provided for displaying the inputted image thereon, and the controller 40 for editing and transmitting information between the user and the game console, wherein the display further comprises a touch screen 31 electrically mounted on a top surface of the display 30, so that the user is able to input, edit, or select the functions of the game console through the display 30 and the controller 40. In order words, the inputted image is showed on the display 30 for editing purpose through the controller 40 and the display 30 via the editor 21.

Accordingly, the controller 40 generally comprises an operational button and functional buttons to operate and control the video game, wherein the operational button can be a joystick or a set of UP, DOWN, LEFT, and RIGHT buttons to select the object on the display 30 in a directional manner. The functional buttons can be a set of selection buttons to input the selected object on the display 30. Therefore, by using the controller 40 of the game console, the user is able to play the video game and to operate the editor 21 through the display 40 for editing the image.

In order to enhance the portability and convenience of making photo-sticker via the game console, a built-in lens 60 is further provided to incorporate with the game console, wherein the built-in lens 60 is capable of capturing the image and inputting the image information to the storage 20 of the game console for later editing purpose by the editing software21 for making the photo-sticker.

It is appreciated that with the built-in lens 60, the user is able to take a picture as the image anywhere and anytime, and input the captured image to the storage 20 for further photo-sticker editing, such that the edited image of photo-sticker can be temporarily saved in the storage 20 or outputted to a printing device for printing out image, so as to accomplish making the photo-sticker. You may also purchase photo sticker print, so that the edited photo sticker is able to be outputted to the printing device to print out the photo sticker via the photo sticker print. The edited image may be made into variety of personal stamps.

The editor 21 comprises an editing interface 211 showed on the display 30 for selecting or editing purpose via the communicating device, such as the controller 40, wherein the interface comprises a plurality of functions for editing the image of the photo-sticker, wherein the functions include a plurality of templates for selecting and adding onto the image, such as selecting a background template and replacing the original background of the image inputted to the storage 20 of the game console, or adding one of the rim or frame templates to the peripheral edge of the image, and setting functions such as date, size of the image, or how many copies per page etc.

The editor 21 stored in the storage 20 of the game console is capable of editing the ordinary image into an extraordinary photo-sticker. For instant, making a photo of the image into the photo-sticker having a plurality of special effects such as the different templates of background or rim, and light effects for making the normal photo looks bright, dark, shiny, or old fashion. The setting function of the editor 21 also allows the user to print out the photo-sticker according to a size and an arrangement as the user expected. For instances, the editor 21 may have many of high quality of collection of frames or preset figures that are able to give you virtually limitless selections to decorate your favorite picture into interesting photo-stickers, so as for sending out the personalized photo stickers as a stamp, postcard, or email to friends.

Therefore, the editor 21 of the game console comprises an interface including a plurality of functions, set up, etc., wherein the functions have a plurality of templates for selectively adding a background, rim, or the likes to the image obtained by the game console. The functions of the editing software also have a plurality of effects, such as a light effect for making the image darker, brighter, old fashion style, and shiny, a twist effect for making the image twisted in an artist purpose, and the likes. The editor 21 further has a decoration function, wherein the decoration function allows the user to add a plurality of saved-into-storage images on the obtained image from the external device or the built-in lens, such as an apple, a cloud, a flower, a dog, or a car.

The editor 21 also includes a set up function, wherein the set up function is provided for selectively choosing a size and/or the arrangement of the photo-sticker. For example, the set up function allows the user to select the way to make the photo-sticker two in a row. Through the functions of the editing software for the user selectively editing the image, the user can enjoy editing the image to be the photo-sticker simply via the game console.

After edited the image to the photo-sticker, the edited image is being temporarily saved and is able to be transmitted to a computer or the printing device for making the photo-sticker through the transmitting device 50 of the game console, wherein the edited image is able to be outputted to the printing device wirelessly or by wire through the transmitting device 50. In other words, after edited the image, the game console is capable of sending out the image for making the photo-sticker by wire through the connecting slot 51 of the transmitting device 50, or wirelessly through the transmitting device 50 outputting the image to the computer, the printing device, or the likes to make the photo-sticker. It is worth mentioning that when the transmitting device 50 of the game console has an Internet function, the transmitting device 50 is adapted for sending out the edited image through Internet, such as email, as a web based storage. Therefore, the user and/or recipient can receive the edited image by downloading the edited image from the web based storage to make the photo-sticker.

It will be readily appreciated by one skilled in the art, the game console for making the photo sticker may further has an internal printing device integrally and electrically connected to the game console, so that the photo sticker prints may be able to be refilled for printing out the edited photo stickers or the likes directly from the integrally portably printing device of the game console.

According to the preferred embodiment of the present invention, the interface 211 preferably comprises at least a functional selections menu, which provides the above mentioned functions for selectively choosing the designed templates or themes, such as above described frames, rims, patterns, figures, or backgrounds. The functional selections menu may further has a text functional selection, which preferably enables the user to selectively choose the color, font, or size of the text, so that the user is able to input letters, numbers, or symbols on the image to form the photo sticker. The interface 211 of the editor 21 further comprises a setting menu, which preferably allows the user to select their preferred settings, such as above described size or pixels of the photo sticker.

It is important to mention that the communicating device, which may includes the display 30 and the controller 40 for controllably and communicatively typing, selecting, editing, inputting, and/or outputting the images for being edited and designed to form the desired photo stickers. The touch screen 31 optionally provided at a position overlapping above the display 30 and electrically connecting to the processing system 10 is able to further simply the operation of creating the photo sticker. The user may be able to freely hand writing or drawing any lines on the image to form the photo sticker via the touch screen 31.

The controller 40 of communicating device could be any existing game controllers or keyboard integrally or externally to electrically connect to the processing system 10 for editing the images to make the photo stickers.

To sum up, the method for making the photo sticker enables the user to edit any ordinary photo images into the photo stickers with extraordinary designs easily, and print it out, save it, redo, erase, or delete the edited images freely, which are limited functions of the existing vending machines. The user does not have to go to the limited vending machines stores. The built-in lens 60 further allows the user to capture the images anywhere and anytime, and uploaded directly to the storage 20 of the game console for conveniently editing the image and turning the images into creative photo sticker. The user-friendly interface 211 of the editing software21 allows the non-professional user, even the kids, to easily create and make the extraordinary photo stickers simply via the game console, so as to allow the user being able to use the controller of game console, which they may be already familiar with.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A portable game console for playing game, comprising:
a storage for storing at least an image to be edited therein;
a display for not only graphically displaying a game image but also displaying said image;
a controller as an input for controllably playing said video game; and
a photo-sticker maker, which comprises an editor being operatively controlled by said controller for adding a special effect on said image posted on said display and for making said image in a photo-sticker format to be outputted from said game console, such that said game console not only provides a video game function for enabling a user to play video game but also provides an added-on photo-editing function for allowing said user to make photo-sticker in one single portable device.

2. The portable game console, as recited in claim 1, wherein said editor comprises an interface to be operatively controlled by said controller, wherein said interface has a template function for selectively adding a background, rim, and template to said image, an effect function for creating various light effect on said image, a decoration function for adding given image on said image, and a set up function for selectively choosing a size and arrangement of said image to become said photo-sticker format.

3. The portable game console, as recited in claim 2, further comprising a built-in lens for capturing said image to be stored in said storage.

4. The portable game console, as recited in claim 2, further comprising a connecting slot for externally connecting to an external device to obtain said image therefrom and to be stored in said storage.

5. The portable game console, as recited in claim 3, further comprising a connecting slot for externally connecting to an external device to obtain said image therefrom and to be stored in said storage.

6. The portable game console, as recited in claim 5, wherein said display is a touch screen operatively linked to said editor that said image is posted on said display and is edited through a control of said display.

7. The portable game console, as recited in claim 6, further comprising means for outputting said image in photo-sticker format to an external device selected from the group consisting of computer and printer.

8. The portable game console, as recited in claim 7, further comprising means for wirelessly connecting an external device selected from the group consisting of computer, printer, camera and hard drive.

9. The portable game console, as recited in claim 8, wherein said controller comprises a directional button and a set of selection buttons for playing said video game and for functional selection of said editor.

10. A method of making an image in a photo-sticker format via a portable game console having a display, a storage, and a controller to play a video game, wherein the method comprises the steps of:
a) posting said image on said display, wherein said image is stored in said storage;
b) editing said image by an editor of a photo-sticker maker; and
c) making said image into a photo-sticker format.

11. The method as recited in claim 10 wherein the step (b) further comprises the steps of:
b.1) selectively adding a background, rim, and template to said image;
b.2) creating various light effect on said image;
b.3) adding given image on said image; and
b.4) selectively choosing a size and arrangement of said image to become said photo-sticker format.

12. The method, as recited in claim 11, wherein the step (a) further comprises a step of capturing said image to be stored in said storage via a built-in lens provided at said game console.

13. The method, as recited in claim 11, wherein the step (a) further comprises a step of externally connecting to an external device to obtain said image therefrom and to be stored in said storage.

14. The method, as recited in claim 12, wherein the step (a) further comprises a step of externally connecting to an external device to obtain said image therefrom and to be stored in said storage.

15. The method, as recited in claim 14, further comprising a step of outputting said image in photo-sticker format to an external device selected from the group consisting of computer and printer.

16. The method, as recited in claim 15, wherein said editor is operated and controlled by said controller such that said controller not only operatively play said video game but also operatively control said editor to edit said image.

17. The method, as recited in claim 16, wherein said controller comprises a directional button and a set of selection buttons for playing said video game and for functional selection of said editor.

18. The method, as recited in claim 17, wherein said editor is operated and controlled by said display which is a touch screen.

19. The method, as recited in claim 18, further comprising a step of wirelessly connecting an external device selected from the group consisting of computer, printer, camera and hard drive.

20. The method, as recited in claim 19, further comprising a step of saving said image in photo-sticker format in said storage.
